(19) United States
(12) Patent Application Publication
(10) Pub. No.: US 2006/0197390 A1
(43) Pub. Date: Sep. 7, 2006

(54) Electric motor seal

(76) Inventors: Thomas Peterreins, Nuernberg (DE); Dieter Popp, Fuerth (DE); Mounir Kudsi, Nuernberg (DE)

Correspondence Address: JACOBSON HOLMAN PLLC, 400 SEVENTH STREET N.W., SUITE 600, WASHINGTON, DC, 20004, US

(21) Appl. No.: 11/365,662

(22) Filed: Mar. 2, 2006

(30) Foreign Application Priority Data
Mar. 4, 2005 (DE) 10 2005 009 928.9

(51) Int. Cl. H02K 23/40

(52) U.S. Cl. 310/40 R

(57) ABSTRACT

An electric motor 1 consisting of a stator 4 comprising a housing 3, a rotor 5 which comprises a shaft 6 mounted in such a manner that it can rotate in the stator 4, and a sealing element 2 which seals a rotor space 7 enclosed by a housing 3 from an additional space 8 contaminated with harmful materials. The sealing element 2 consists of an elastic sealing plate 9 of at least approximately constant thickness, said elastic sealing plate comprising a central recess 10 which receives a section of the shaft 6 and an annular surface area 11 in contact with the housing 3, and an arrester plate 12 which is pressed firmly onto the shaft 6 and causes the contact of the sealing plate 9 with the housing 3, and that the distance between one side of the arrester plate 12, specifically the front side facing the housing 3, and the housing area 15 in contact with the sealing plate 9 is less than the thickness of the sealing plate 9.

### TECHNICAL FIELD OF THE INVENTION

The invention relates to electric motors, in general, and to an electric motor consisting of a stator having a housing, a rotor which comprises a shaft mounted in such a manner that it can rotate in the stator, and a sealing element which seals a rotor space enclosed by the housing from an additional space contaminated with harmful materials, in particular.

### BACKGROUND OF THE INVENTION

The construction of a generic electric motor is discussed in DE 25 11 084 A1. Therein a sealing element consists of a plane sealing ring being supported on a pinion. The plane sealing ring comprises a fastening area and a sealing area. The plane sealing ring has a relatively complicated construction, making it difficult to fabricate. In addition to this, a relatively large axial installation space is required. A seal is created between the rotor and stator/housing of the motor by the plane sealing ring rubbing against the stator/housing. This friction connection is not allowed to be too tight so that frictional losses are kept low. Further, the sealing ring cannot be too small because in that case the sealing action is too loose.

If the seal is too rigid, the pinion on which the plane sealing ring is supported must be positioned very precisely in order to adjust the frictional force so that it is optimal. This precise positioning is very complicated and expensive to implement. Through unavoidable wear of the plane sealing ring, the sealing action is impaired because the plane sealing ring is not elastic enough due to its small diameter.

### SUMMARY OF THE INVENTION

It is thus the object of the invention to present, in the simplest manner and with the simplest means, a sealing element permitting great tolerances, in which sealing element the sealing function is retained even with certain wear of the sealing materials and a compression in thickness of the sealing plate is avoided so that frictional losses always remain low.

This object is realized according to the invention by providing a sealing element that consists of an elastic sealing plate of a substantial or approximate constant thickness. The elastic sealing plate defines a central recess, which receives a section of the shaft that defines the rotor. The sealing plate also has an annular surface area in contact with the housing. An arrester plate is pressed firmly onto the shaft and causes contact of the sealing plate with the housing, so that the distance between one side of the arrester plate, specifically the front side facing the housing, and the housing area or portion of the housing in contact with the sealing plate is less than the thickness of the sealing plate.

By providing the sealing plate with a constant thickness, the sealing plate can be produced relatively simply and economically. The arrester plate permits a precise adjustment of the frictional force between the sealing plate and housing independently of the position of functional elements, such as a pinion or eccentric, disposed on the shaft. The slight distance between the arrester plate and the housing causes a slight flexing or arching of the sealing plate so that it securely abuts the housing. This slight deformation requires hardly any force so that the frictional force is also small.

Expediently the sealing plate consists of an elastomeric material because this can adapt most easily to slight irregularities in the housing in order to achieve good sealing action. It is important that the sealing plate is flat in the pre-mounting state because a definite initial load can be set more easily thereby. Finally, it is particularly advantageous if the sealing plate is a punched part. Thereby large numbers of pieces of the sealing plate can be produced in a particularly simple manner, with simple tools and in one production step.

In order to achieve a good sealing action it is important to seal the elastomeric plate with respect to the shaft. In order to achieve this it is provided that the sealing plate is fastened to the shaft in such a manner that it cannot rotate. In order to achieve this, the sealing plate is pressed onto the shaft. Thus, there is friction between an annular area of the sealing plate and the housing area in contact with it during the operation of the motor with little normal force and thus little frictional force.

The electric motor with the sealing element described can, by way of example, be used as a drive for an exhaust gas recirculation valve in a motor vehicle because there conditions exist which require a sealing of the electric motor.

### BRIEF DESCRIPTION OF THE DRAWINGS

For a better understanding of the present invention and its advantages, reference should be made to the accompanying drawings, in which:

FIG. 1 a section through an electric motor in the area of a sealing element,

FIG. 2 a sealing plate, and

FIG. 3 an arrester plate.

### DETAILED DESCRIPTION OF THE INVENTION

In describing preferred embodiments of the present invention illustrated in the drawings, specific terminology is employed for the sake of clarity. However, the invention is not intended to be limited to the specific terminology so selected, and it is to be understood that each specific element includes all technical equivalents that operate in a similar manner to accomplish a similar purpose.

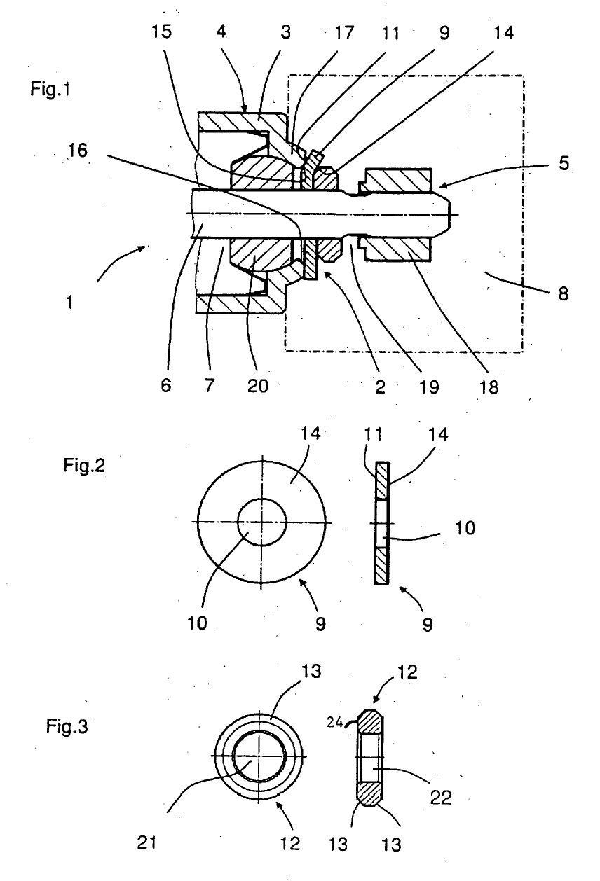

FIG. 1 shows a section through an electric motor 1 in the area of a sealing element 2, with a shaft 6 mounted in a bearing 20 as part of a rotor 5 and a housing 3 as part of a stator 4. The housing 3 is deep-drawn and comprises an area 17 to receive the bearing, said area comprising a contact area 15 with which a sealing plate 9 is in contact and which is supported in the axial direction by an arrester plate 12 pressed onto the shaft 6. Outside of a rotor space 7 a functional part in the form of a pinion 18 is fastened to the shaft 6. The shaft includes a notch 19 between the sealing element 2 and pinion 18. The contact area 15 of the deep-drawn housing 3 is formed in the form of a chamfer 16 inclined relative to the shaft 6. The arrester plate 12 comprises a chamfer 13 (FIG. 3) which serves to make the sealing plate 9 easier to arch or flex. The sealing element separates the rotor space 7 from a contaminated exterior space 8 which is indicated here only by a dotted line in FIG. 1.

The sealing plate 9 and the arrester plate 12 are represented in two extreme fitting positions; the upper part of the plate showing the maximum proximity of the arrester plate to the motor housing and the lower part of the plate showing the minimum proximity which is just barely permitted in order to achieve the desired sealing action. Between these two limit positions is the tolerance range within which the arrester plate may be found after its mounting. This tolerance range is particularly large here so that a reliable mounting can be achieved in a simple manner.

FIG. 2 shows the sealing plate 9 with its contact area 11 with the housing, its contact area 14 with the arrester plate, and a central recess or aperture 10 to receive the shaft. The sealing plate is formed to be completely symmetrical.

FIG. 3 shows the arrester plate 12 with its chamfers 13 disposed symmetrically on both sides and a central recess or aperture 22 for the shaft.

By providing the sealing plate 9 with a constant thickness, the sealing plate can be produced relatively simply and economically. The arrester plate 12 permits a precise adjustment of the frictional force between the sealing plate 9 and housing 3 independently of the position of functional elements, such as the pinion 18 or eccentric, disposed on the shaft. The slight distance between the arrester plate 12 and the housing 3 causes a slight flexing or arching of the sealing plate 9 so that it securely abuts the housing. This slight deformation requires hardly any force so that the frictional force is also small.

Expediently the sealing plate 9 consists of an elastomeric material because this can adapt most easily to slight irregularities in the housing 4 in order to achieve good sealing action. It is also important that the sealing plate is flat in the pre-mounting state because a definite initial load can be set more easily thereby. Finally, it is particularly advantageous if the sealing plate 9 is a punched part. Thereby large numbers of pieces of the sealing plate can be produced in a particularly simple manner, with simple tools and in one production step.

If the distance between the one side of the arrester plate 12, specifically the front side facing the housing 3, and the housing area 15 in contact with the sealing plate 9 is greater than zero, it is ensured that the sealing plate is not clamped in.

In the ideal situation, the action of the arrester plate 12 on one side and the housing 3 on the other side, creates a situation where the sealing plate 9 is not arched, is not crimped, and cannot be achieved in that width. Thus, a slight arching is strived for, while crimping of the sealing plate must be reliably avoided.

The frictional force can be kept particularly low if the diameter of the arrester plate 12 is clearly less than the diameter of the sealing plate 9, in particular the tolerance range with respect to the position of the arrester plate relative to the housing is increased thereby.

Since the arching of the sealing plate 9 is necessary, an increase in friction that arises due to edges which could be present on the parts causing the arching, must be avoided. Thus the arrester plate 12 comprises on its side 24 facing the sealing plate 9 a rounding or a chamfer 13 on which an annular area 14 of the sealing plate 9 can be laid. Thus the contact area 15 of the housing 3 with the sealing plate 9 is also rounded or is a chamfer 16 inclined relative to the shaft 6.

In order to achieve a good sealing action it is important to seal the elastomeric plate 9 with respect to the shaft 6. In order to achieve this, the sealing plate 9 must be fastened to the shaft 6 in such a manner that it cannot rotate. In order to achieve this, the sealing plate 9 is pressed onto the shaft 6. Thus, there is a friction fit between an annular area of the sealing plate 9 and the housing area 15 in contact with it during the operation of the motor with little normal force and thus little frictional force.

The arrester plate 12 consists of a metal ring, for example, a brass ring. It can thus be produced in a simple manner.

The electric motor according to the invention preferably comprises a deep-drawn housing 3, where the area 15 in contact with the sealing plate 9 remains mechanically unprocessed after the deep-drawing. This offers significant economic advantages because one production step can be omitted completely. A good sealing action is nonetheless secured due to the special geometry of the sealing element.

In order not to have to take special precautions that the arrester plate is properly mounted, it is preferable to shape the arrester plate in a symmetrical form.

The electric motor with the sealing element described can, by way of example, be used as a drive for an exhaust gas recirculation valve in a motor vehicle because there conditions exist which require a sealing of the electric motor.

Modifications and variations of the above-described embodiments of the present invention are possible, as appreciated by those skilled in the art in light of the above teachings. It is therefore to be understood that, within the scope of the appended claims and their equivalents, the invention may be practiced otherwise than as specifically described. Modifications and variations of the above-described embodiments of the present invention are possible, as appreciated by those skilled in the art in light of the above teachings. It is therefore to be understood that, within the scope of the appended claims and their equivalents, the invention may be practiced otherwise than as specifically described.

What is claimed is:

1. An electric motor used in an external space, the motor comprising:
a housing forming part of a stator, the housing defining a rotor space;
a shaft forming a rotor, the rotor mounted in such a manner that it can rotate in the stator; and
a sealing element for isolating the rotor space from the external space, wherein the sealing element consists of
an elastic sealing plate of approximately constant thickness with opposed first and second surface areas,
a central recess defined in said sealing plate, the central recess for receiving a section of the shaft, said first annular surface area being in contact with the housing; and
an arrester plate press-fit firmly onto the shaft to cause the first annular surface area of the sealing plate to be in contact with the housing, wherein the distance between one side of the arrester plate, specifically the front side facing the housing and the portion of the housing in sealing contact with the sealing plate is less than the thickness of the sealing plate.

2. The electric motor according to claim 1, wherein the sealing plate is made of an elastomeric material.

3. The electric motor according to claim 1, wherein the sealing plate is flat in its pre-mounting state.

4. The electric motor according to claim 1, wherein the sealing plate is a punched part.

5. The electric motor according to claim 1, wherein of the distance between the one side of the arrester plate, specifically the front side facing the housing, and the housing area in contact with the sealing plate is greater than zero.

6. The electric motor according to claim 1, wherein the sealing plate can be arched by the action of the arrester plate on one side and of the housing on the other side but not crimped.

7. The electric motor according to claim 1, wherein the sealing plate is arched by the action of the arrester plate on one side and of the housing on the other side but is not crimped.

8. The electric motor according to claim 1, wherein the diameter of the arrester plate is less than the diameter of the sealing plate.

9. The electric motor according to claim 1, wherein the arrester plate comprises, on its side facing the sealing plate, a rounding or a chamfer on which an annular area of the sealing plate can be laid.

10. The electric motor according to claim 1, wherein the contact area of the housing with the sealing plate is also rounded or is a chamfer inclined relative to the shaft.

11. The electric motor according to claim 1, wherein the sealing plate is fastened to the shaft in such a manner that it cannot rotate.

12. The electric motor according to claim 1, wherein the sealing plate is pressed onto the shaft.

13. The electric motor according to claim 1, wherein there is friction between an annular area of the sealing plate and the housing area in contact with it during the operation of the motor with little normal force and thus little frictional force.

14. The electric motor according to claim 1, wherein the arrester plate consists of a metal ring.

15. The electric motor according to claim 1, wherein the housing is deep-drawn and the area in contact with the sealing plate remains mechanically untreated after the deep-drawing.

16. The electric motor according to claim 1, further comprising means for driving an exhaust gas recirculation valve in a motor vehicle.

17. The electric motor according to claim 1, wherein the arrester plate is shaped to be symmetric.

18. The electric motor according to claim 14, wherein the metal ring is a brass ring.
